(19) United States
(12) Patent Application Publication
(10) Pub. No.: US 2018/0373752 A1
(43) Pub. Date: Dec. 27, 2018

(54) COLUMN-ORIENTED LAYOUT FILE GENERATION METHOD

(71) Applicant: EEDIOM INC., Seoul (KR)

(72) Inventor: Bongyeol Yang, Seoul (KR)

(73) Assignee: EEDIOM INC.

(21) Appl. No.: 16/119,047

(22) Filed: Aug. 31, 2018

Related U.S. Application Data
(63) Continuation of application No. PCT/KR2017/000404, filed on Jan. 12, 2017.

(30) Foreign Application Priority Data
Mar. 11, 2016 (KR) 10-2016-0029589

(51) Int. Cl. G06F 17/30; G06F 21/62

(52) U.S. Cl. CPC G06F 17/30377; G06F 2221/2107; G06F 21/6245; G06F 17/30315

(57) ABSTRACT

A computer-implemented method of generating a file is provided herein having a column-oriented layout and including a file header and a data block. The method includes a step of inserting a field header into the data block and a step of inserting a block, which supports encoding of a variable type field value array, into the field header.

### CROSS-REFERENCE TO RELATED APPLICATION

This application is a continuation application of International Application No. PCT/KR2017/000404 filed on Jan. 12, 2017, which claims priority to Korean Application No. 10-2016-0029589 filed on Mar. 11, 2016. Both applications are incorporated herein by reference in their entirety.

### TECHNICAL FIELD

The present disclosure relates to methods, devices, and systems for generating a file having a column-oriented layout, and more specifically, to methods, devices, and systems for generating a file having a column-oriented layout that can be analyzed at a high speed even without defining a schema.

### BACKGROUND

In a hyper-connect era, a large amount of sensor data is collected from various machines in real-time. There has been a technique used that multi-dimensionally analyzes the data through a preprocess, for example creation of an OLAP cube or the like.

Column-oriented database techniques have also been developed after MonetDB/X100 appeared in 2005, thereby necessitating analysis of a large amount of data at a high speed without performing a preprocess.

Although Hadoop-based data warehouse (HIVE) and the like have implemented a technique capable of analyzing a column-oriented database at a high speed through an ORC or the like, it is difficult to apply the technique to the big data because, in the big data environment, there are many cases where a schema is changeable. In addition, security problems have also emerged in big data, including concerns over personal information. Thus, methods, devices, and systems are needed for generating a file having a column-oriented layout.

### SUMMARY

Methods, systems, and devices are provided for generating a file having a column-oriented layout, and more specifically, for generating a file having a column-oriented layout that can be analyzed at a high speed even without defining a schema. In one embodiment, a method of generating a file having a column-oriented layout is provided that can solve one or more problems described above.

In another embodiment, a computer-implemented method is provided of generating a file having a column-oriented layout and including a file header and a data block. The method includes a step of inserting a field header into the data block and a step of inserting a block, which supports encoding of a variable type field value array, into the field header.

When field values include data of different types, the present disclosure may include a step of creating the field value array to include array type identification information, array length information, and array element information and a step of creating the array element information to include identification information of element, length information of element, and value data of element.

When field values include data of the same type and are configured to be an integer value array, the present disclosure may include a step of creating the field value array to include array type identification information, a null bitmap, maximum bit, and the integer value array and a step of encoding the integer value array by the predetermined number of units while the unit has the maximum bit.

When field values include data of the same type and are configured to be a character string value array, the present disclosure may include a step of creating the field value array to include array type identification information, a null bitmap, maximum bit, character string length information, and the character string value array and a step of encoding the character string value array by the predetermined number of units while the unit has the maximum bit.

When field values include data of the same type and are configured as a dictionary array, the present disclosure may include a step of creating the field value array to include array type identification information, information on the number of dictionary character strings, dictionary length information, dictionary name information, a null bitmap, a maximum bit, and dictionary identification information and a step of encoding the dictionary array by the predetermined number of units while the unit has the maximum bit.

The field header may include information on the entire size of the field header, information on the number of fields (variable type), information on a length of a field name (variable type), information on a length of an original field (variable type), information on a length of a compressed field (variable type), and information on the field name. The predetermined number may be eight.

In another embodiment, a computer-implemented method is provided of analyzing the file having a column-oriented layout generated by the present disclosure. The method includes a step of encrypting each of two or more field value arrays and a step of decrypting only field value arrays on which analysis is required.

According to the present disclosure, a method of storing and analyzing big data is provided where a schema of which is changeable at a high speed and of generating and analyzing a file having a column-oriented layout that is excellent from the aspects of security and analysis speed because encoding and decoding are performed on each column.

### BRIEF DESCRIPTION OF DRAWINGS

The invention will be more fully understood from the following detailed description taken in conjunction with the accompanying drawings.

FIG. 1 shows one embodiment of a structure of a file having a column-oriented layout according to the present disclosure.

FIG. 2 shows one embodiment of a structure of a field header of a file having a column-oriented layout according to the present disclosure.

FIG. 3 shows one embodiment of a structure of a field value array of a file having a column-oriented layout according to the present disclosure when data types are different from each other.

FIG. 4 shows one embodiment of a structure of a field value array of a file having a column-oriented layout according to the present disclosure when data types are the same and field values are integer.

FIG. 5 shows one embodiment of a structure of a field value array of a file having a column-oriented layout according to the present disclosure when data types are the same and field values are character string.

FIG. 6 shows one embodiment of a structure of a field value array of a file having a column-oriented layout according to the present disclosure when data types are the same and field values are dictionary value.

FIG. 7 shows one embodiment of an exemplary field value array structure for describing the field value array of FIG. 6.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION

Hereinafter, the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

In this specification, the order of each step should be understood in a non-limited manner unless a preceding step must be performed logically and temporally before a following step. That is, except for the exceptional cases as described above, although a process described as a following step is preceded by a process described as a preceding step, it does not affect the nature of the present disclosure, and the scope of rights should be defined regardless of the order of the steps. In addition, in this specification, “A or B” is defined not only as selectively referring to either A or B, but also as including both A and B. In addition, in this specification, the term “comprise” has a meaning of further including other components in addition to the components listed.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. The term “coupled” denotes a physical relationship between two components whereby the components are either directly connected to one another or indirectly connected via one or more intermediary components. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The method according to the present disclosure can be carried out by an electronic arithmetic device such as a computer, tablet, mobile phone, portable computing device, stationary computing device. etc. Additionally, it is understood that one or more various methods, or aspects thereof, may be executed by at least one processor. The processor may be implemented on a computer, tablet, mobile device, portable computing device, etc. A memory configured to store program instructions may also be implemented in the device(s), in which case the processor is specifically programmed to execute the stored program instructions to perform one or more processes, which are described further below. Moreover, it is understood that the below methods may be executed by a computer, tablet, mobile device, portable computing device, etc. including the processor, in conjunction with one or more additional components, as described in detail below. Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

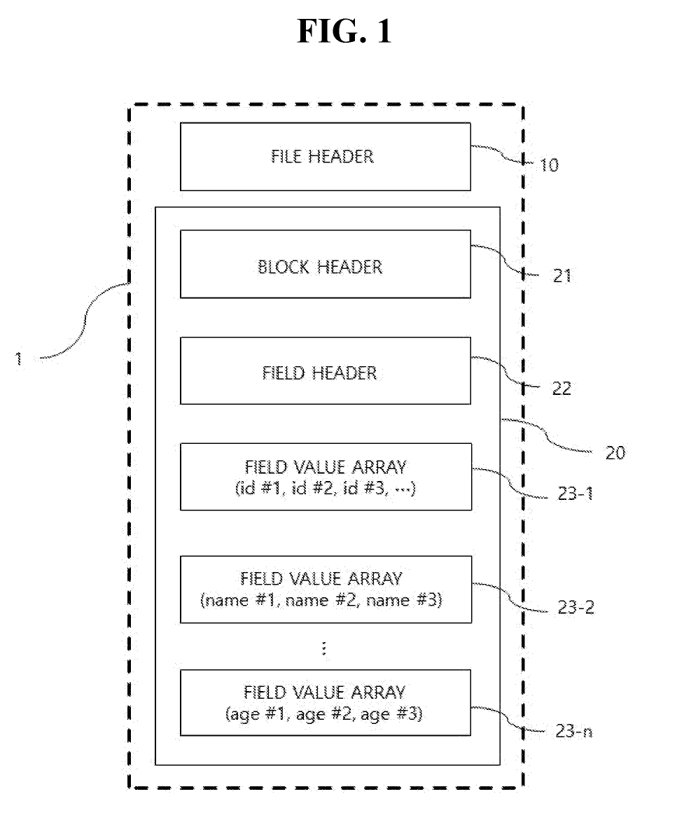

FIG. 1 shows a structure of a file having a column-oriented layout according to one embodiment the present disclosure. As shown in FIG. 1, a file (1) having a column-oriented layout can include a file header (10) and a data block (20). A field header (22) is inserted into the data block (20). The data block (20) also can include a block header (21) and field value arrays (23-1, 23-2, . . . , 23-n).

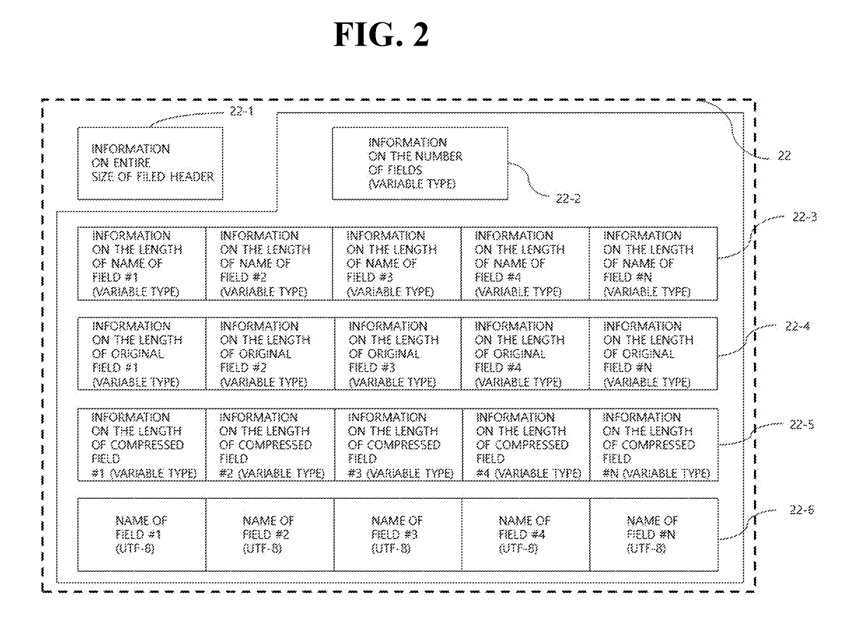

FIG. 2 shows a structure of a field header (22) of a file having a column-oriented layout. The field header (22) can include the information (22-1) on the entire size of the field header, the information (22-2) on the number of fields, the information (22-3) on the length of a field name, the information (22-4) on the length of an original field, the information (22-5) on the length of a compressed field, and the information (22-6) on the field name. Because the information (22-2) on the number of fields, the information (22-3) on the length of a field name, the information (22-4) on the length of an original field, and the information (22-5) on the length of a compressed field are defined as a variable type, variable type encoding is possible even though a schema (a data structure) is not defined in advance.

If big data is configured to be a file having a column-oriented layout, the efficiency is drastically improved when values of a specific field are needed compared with the conventional technique that reads an entire row because only the specific area needs to be retrieved and analyzed. In some techniques, a field value having a different data type cannot be inserted because a schema is predefined. However, as discussed herein, even big data where schema is changeable can be recorded and analyzed in an efficient and speedy way by a column-oriented database technique because a field value having a different data type can be inserted.

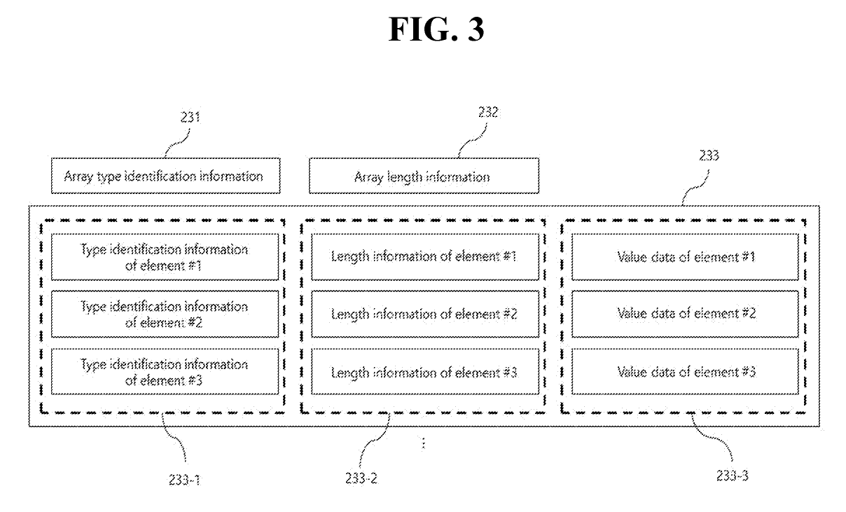

FIG. 3 shows a detailed structure of the field value arrays (23-1, . . . , 23-n). Each of the field value arrays (23-1, . . . , 23-n) can be individually encrypted and decrypted. An initial vector used for encryption can be recorded in the block header (21). The initial vector may be a different value for each column of the data block (20) or may be the same value for all of the columns of the data block (20). In an embodiment where each column is individually encrypted and decrypted, only a data column that needs security, for example, a data column of personal information, can be encrypted, decrypted and analyzed, thereby providing advantageous effects in the aspects of security and analysis speed.

In the case of a field value array having data of different types, the field value array can include array type identification information (231), array length information (232), and array element information (233) as shown in FIG. 3. The array element information (233) can include type identification information (233-1) of element, length information (233-2) of element, and value data (233-3) of element.

When the field value array has data of the same type, encoding can be optimized for high speed of data analysis. Hereinafter, an example of an optimized encoding method will be described.

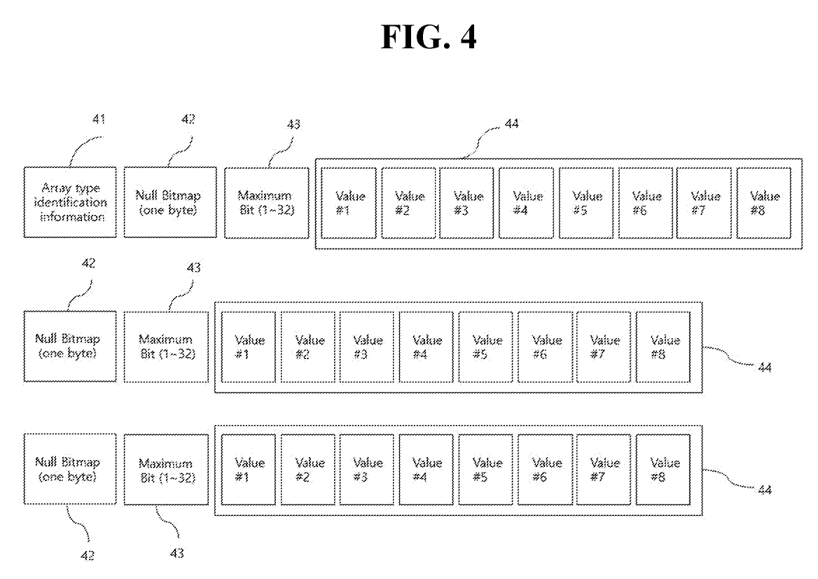

FIG. 4 shows a structure of a field value array in an embodiment where the field value array is configured to have data of the same type and the field value is integer. As shown in FIG. 4, the field value array can include array type identification information (41), a null bitmap (42), maximum bit information (43), and an array of integer values (44). The array of integer values (44) may be encoded by the predetermined number (i.e., eight) of units, each of which can have the maximum bit. For example, if the maximum bit is four, the field value array may be encoded by the eight units, each of which has 4 bits and become four bytes, and if the maximum bit is eight, the field value array is encoded by the eight units, each of which has 8 bits and can become eight bytes. There is an effect of minimizing the overhead of reading if the field value array is encoded by the predetermined number of the units.

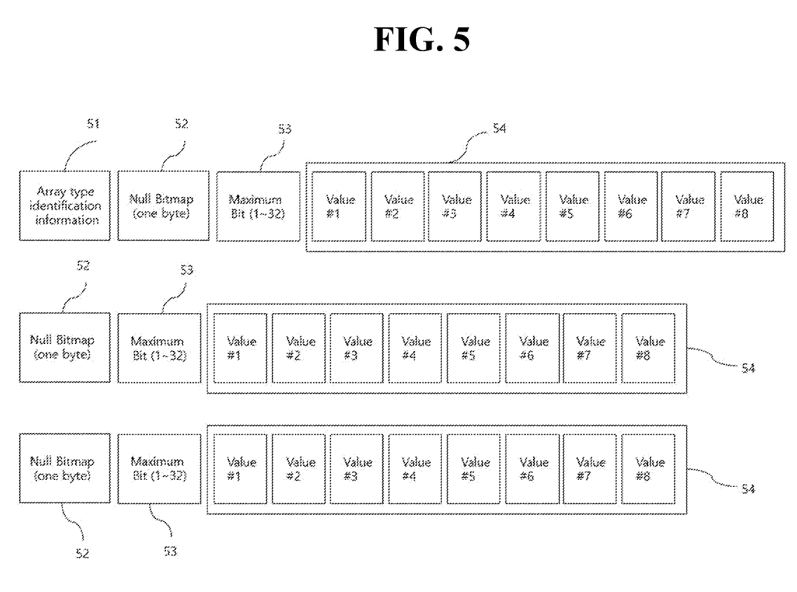

FIG. 5 shows one embodiment of a structure of a field value array when the field value array is configured to have data of the same type and the field values are character string values. As shown in FIG. 5, the field value array can be generated to include array type identification information (51), a null bitmap (52), a maximum bit (53) and a character string value array (54). As in the integer value array, the character string value array (54) may be encoded by the predetermined number (i.e., eight) of units, each of which can have the maximum bit. For example, if the maximum bit is four, the field value array can be encoded by the eight units, each of which has 4 bits and can become four bytes, and if the maximum bit is eight, the field value array is encoded by the eight unit, each of which has 8 bits and can become eight bytes. There is an effect of minimizing the overhead of reading if the field value array is encoded by the unit of a predetermined number like this.

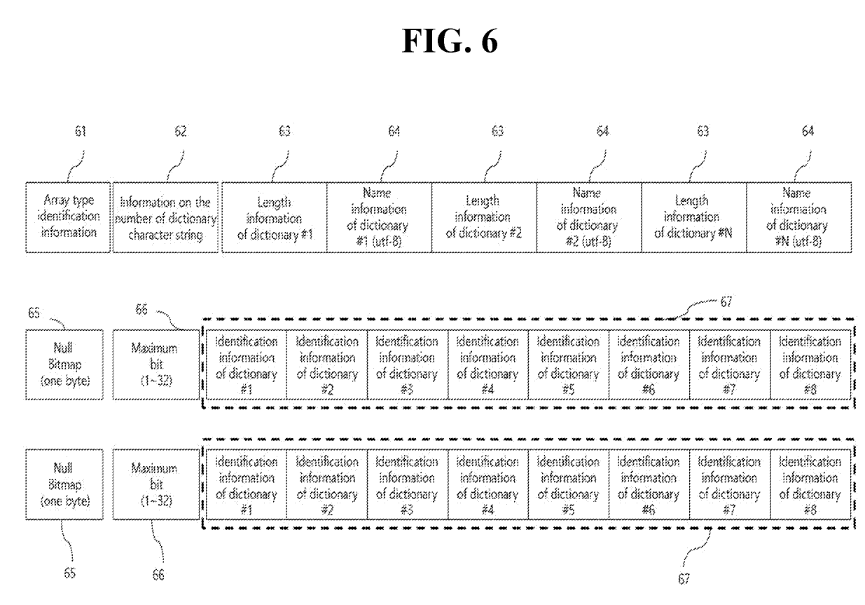

FIG. 6 shows one embodiment of a structure of a field value array when the field value array is configured to have data of the same type and the field values are dictionary values. As shown in FIG. 6, the field value array can be generated to include array type identification information (61), the information on the number of dictionary character strings (62; variable type), the information (63) on the length of dictionary value, the information (64) on dictionary name, a null bitmap (65), a maximum bit (66), and a dictionary identification information array (67). As in the integer value or character string value array, the dictionary value array (67) may be encoded by the predetermined number (i.e., eight) of the units, each of which can have the maximum bit. For example, if the maximum bit is four, the field value array is encoded by the eight units, each of which has 4 bits and can become four bytes, and if the maximum bit is eight, the field value array is encoded by the eight units, each of which has 8 bits and can become eight bytes. There is an effect of minimizing the overhead of reading if the field value array is encoded by the predetermined number (i.e., eight) of the units.

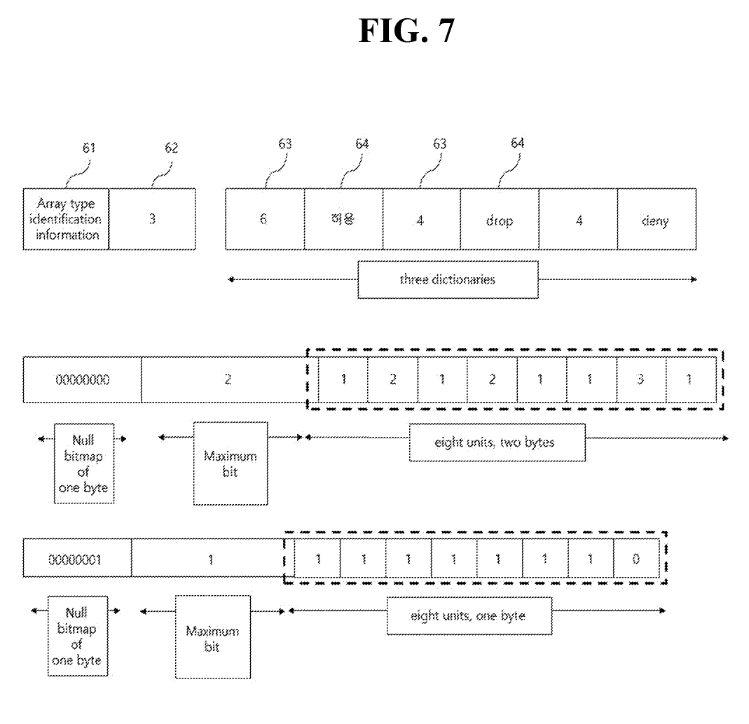

This will be described in more detail with reference to FIG. 7. In the example of FIG. 7, there is a dictionary value array having only three kinds of words, “ [symbol] ”, “deny”, and “drop” in a specific field. In the example, the actually collected log data is “ [symbol] ”, “drop”, “ [symbol] ”, “drop”, “ [symbol] ”, “ [symbol] ”, “deny”, “ [symbol] ”, “ [symbol] ”, “ [symbol] ”, “ [symbol] ”, “ [symbol] ”, “ [symbol] ”, “ [symbol] ”, “ [symbol] .”

In this case, three dictionaries are extracted in the process of generating a data block of a corresponding file. The array type identification information (61) of the dictionary value and the information on the number of dictionary character strings, i.e., “3”, are arranged at the beginning of the field array. Then, the dictionary length information (63) and the dictionary name information (64) are arranged. When the dictionary name information is stored in the “utf-8” format, the length information of “ [symbol] ,” which is a Korean character, becomes six bytes, and the length information of “deny” and “drop,” which are English characters, becomes four bytes.

Then, the null bitmap (65) and the maximum bit are arranged. If it is assumed that the field value array is encoded by eight units, the null bitmap is determined as “00000000” because there are eight data from the beginning, and the maximum bit is set to two bits because there are three kinds of data in the eight units at the beginning. Because this part is encoded by the eight units, each of which has the maximum bit of “2”, the length of data becomes two bytes.

For the field values from ninth unit to fifteenth unit, the null bitmap is set to “00000001” because there are only seven data. The maximum bit is set to “1” because there is only one dictionary kind of “ [symbol] .” The data are encoded by eight units, each of which has maximum bit of “1,” and the length of data becomes one byte.

Although the present disclosure has been described with reference to accompanying drawings, the scope of the present disclosure is determined by the claims described below and should not be interpreted as being restricted by the embodiments and/or drawings described above. It should be clearly understood that improvements, changes and modifications of the present disclosure disclosed in the claims and apparent to those skilled in the art also fall within the scope of the present disclosure. Accordingly, this description is to be taken only by way of example and not to otherwise limit the scope of the embodiments herein.

What is claimed is:

1. A computer-implemented method of generating a file having a column-oriented layout and comprising a file header and a data block, the method comprising:
inserting a field header into the data block; and
inserting a block that supports encoding of a variable type field value array into the field header.

2. The computer-implemented method according to claim 1, further comprising:
when field values are data of different types, creating the field value array to include array type identification information, array length information and array element information; and
creating the array element information to include identification information of element, length information of element and value data of element.

3. The computer-implemented method according to claim 1, further comprising:
when field values are data of the same type and are configured to be an integer value array, creating the field value array to include array type identification information, a null bitmap, maximum bit, and the integer value array; and
encoding the integer value array by the predetermined number of units, the unit having the maximum bit.

4. The computer-implemented method according to claim 1, further comprising:
when field values are data of the same type and are configured to be a character string value array, creating the field value array to include array type identification information, a null bitmap, maximum bit, character string length information, and the character string value array; and
encoding the character string value array by the predetermined number of units, the unit having the maximum bit.

5. The computer-implemented method according to claim 1, further comprising:
when field values are data of the same type and are configured as a dictionary array, creating the field value array to include array type identification information, information on the number of dictionary character strings, dictionary length information, dictionary name information, a null bitmap, a maximum bit, and dictionary identification information; and
encoding the dictionary array by the predetermined number of units, the unit having the maximum bit.

6. The computer-implemented method according to claim 1, wherein the field header includes information on the entire size of the field header, information on the number of fields (variable type), information on a length of a field name (variable type), information on a length of an original field (variable type), information on a length of a compressed field (variable type), and information on the field name.

7. The computer-implemented method according to claim 2, wherein the field header includes information on the entire size of the field header, information on the number of fields (variable type), information on a length of a field name (variable type), information on a length of an original field (variable type), information on a length of a compressed field (variable type), and information on the field name.

8. The computer-implemented method according to claim 3, wherein the predetermined number is eight.

9. The computer-implemented method according to claim 4, wherein the predetermined number is eight.

10. The computer-implemented method according to claim 5, wherein the predetermined number is eight.

11. A computer-implemented method of analyzing the file having a column-oriented layout generated according to claim 1, comprising:
encrypting each of at least two field value arrays; and
decrypting only the field value arrays on which analysis is required.

12. A computer-implemented method of analyzing the file having a column-oriented layout generated according to claim 2, comprising:
encrypting each of field value arrays; and
decrypting only field value arrays on which analysis is required.
